(19) United States
(12) Patent Application Publication
(10) Pub. No.: US 2021/0131782 A1
(43) Pub. Date: May 6, 2021

(54) IMAGE CAPTURE MEASURING TAPE

(71) Applicant: Apex Brabds, Inc., Apex, NC (US)

(72) Inventors: Tobias McKay Bridges, Nolensville, TN (US); Kay Randolph Ligon, Raleigh, NC (US); Kevin Fitzpatrick, Apex, NC (US); Vlad Petru Patrangenaru, Ellicott City, MD (US); Ian Cunninggham, Charlotte, NC (US)

(21) Appl. No.: 16/639,426

(22) PCT Filed: Aug. 16, 2018
(86) PCT No.: PCT/IB2018/056181

§ 371 Date: Feb. 14, 2020

Related U.S. Application Data
(60) Provisional application No. 62/546,457, filed on Aug. 16, 2017.

(51) Int. Cl. G01B 3/1094; G01B 3/1041; G01B 3/1056; G01B 3/1061; G01B 3/00; H04N 5/232; H04W 4/38

(52) U.S. Cl. CPC G01B 3/1094; G01B 3/1041; G01B 3/1056; G01B 2003/1087; G01B 3/006; H04N 5/23216; H04W 4/38; G01B 3/1061

(57) ABSTRACT

An example distance measuring apparatus is provided. The example apparatus may include a measuring tape with distance measurement indicia, a camera, and processing circuitry. The processing circuitry may be configured to cause the camera to capture an image of the measuring tape, and determine a measurement by analyzing the captured image. The measurement may be determined based on the distance measurement indicia of the measuring tape within the image at a measurement position. The processing circuitry may be further configured to store the measurement in a memory device.

### CROSS REFERENCE TO RELATED APPLICATIONS

This application claims the benefit of U.S. provisional application No. 62/546,457 filed on Aug. 16, 2017, the entire contents of which are hereby incorporated by reference.

### TECHNICAL FIELD

Example embodiments generally relate to measuring tape devices, and particularly relate to automated measuring tape technologies.

### BACKGROUND

Measuring tapes are common tools used in numerous contexts to obtain linear measurements. While ergonomic and other physical improvements to measuring tapes have been achieved over the years, the same workflow with respect to measuring tapes continues to be used. In short, that workflow is to measure with the tape, mark a measurement, and record the measurement on a notepad or drawing. It is clear that improvements in this area of technology would be beneficial.

### BRIEF SUMMARY OF SOME EXAMPLES

An example distance measuring apparatus is provided. The example apparatus may comprise a measuring tape with distance measurement indicia, a camera, and processing circuitry. The processing circuitry may be configured to cause the camera to capture an image of the measuring tape and determine a measurement by analyzing the captured image. The measurement being determined may be based on the distance measurement indicia of the measuring tape within the image at a measurement position. The processing circuitry may be further configured to store the measurement in a memory device.

Another example distance measuring apparatus may comprise a housing having an aperture, a reel assembly, and a measuring tape having a first end configured to extend from the housing through the aperture and a second end configured to be wound on the reel assembly. The measuring tape may have distance measurement indicia. The example apparatus may further comprise a touch control. The touch control may be configured to send a signal to have a camera capture an image of the distance measurement indicia at a measurement position.

An example method is also provided. The example method may comprise causing the camera to capture an image of a measuring tape. The measuring tape may have distance measurement indicia. The example method may further comprise determining a measurement by analyzing the captured image. The measurement may be determined based on the distance measurement indicia of the measuring tape within the image at a measurement position. The example method may further comprise storing the measurement in a memory device.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a distance measuring apparatus in accordance with an example embodiment;

FIG. 2 illustrates a perspective view of another distance measuring apparatus in accordance with an example embodiment;

FIG. 3 illustrates an example measurement scenario in accordance with an example embodiment;

FIG. 4 illustrates another distance measuring apparatus having distributed functionalities in accordance with an example embodiment;

FIG. 5 illustrates a user utilizing the distance measuring apparatus of FIG. 4 in accordance with an example embodiment;

FIG. 6 illustrates another example measurement scenario in accordance with an example embodiment;

FIG. 7 illustrates another example distance measuring apparatus in accordance with an example embodiment; and

FIG. 8 illustrates an example method of operation for a distance measuring apparatus in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

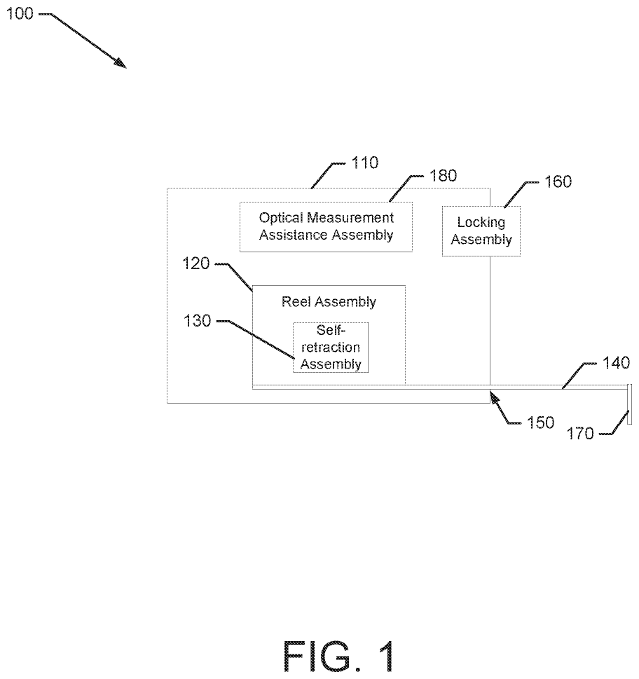

As indicated above, some example embodiments relate to the provision of a measuring tape device that may have improved measurement workflow capabilities. Such improved measurement workflow capabilities may be accomplished by employing image capturing and image analysis technology in relation to tape measures. FIG. 1 illustrates a block diagram of such device, in accordance with an example embodiment.

Referring now to FIG. 1, a distance measuring apparatus 100 of an example embodiment may include a housing 110 inside which a reel assembly 120, and a self-retraction assembly 130 may be provided. A tape 140 of the device 100 may be wound onto the reel assembly 120. The tape 140 may be paid out or retracted in through an aperture 150 formed in the housing 110. Although not required, in some cases, a locking assembly 160 may be provided to enable the reel assembly 120 to be locked to prevent the self-retraction assembly 130 from retracting the tape 140 when the locking assembly 160 is engaged. The locking assembly 160 may include a button or switch that moves to lock the tape 140 in position or unlock the tape 140 and permit the tape 140 to retract into the housing 110.

The tape 140 may have an end hook 170 disposed at one end thereof, and may be affixed to the reel assembly 120 at the other end of the tape 140. The end hook 170 may be affixed (temporarily) to an anchor point on a medium that is to be measured. When the end hook 170 is affixed to the anchor point, the tape 140 may be paid out of the aperture 150 and unwound or rolled out from the reel assembly 120. When a desired length of the tape 140 has been rolled out, the user can make any necessary markings, readings, etc., associated with distance measurement indicia that may be printed on the tape 140. The distance measurement indicia generally indicate a length measurement from the end hook 170 in one or more units (e.g., inches, centimeters, etc.), with divisions and subdivisions of such units clearly marked on the edge of tape 140 with numbering to show integer units of measure. The distance measurement indicia may include measurement numbers and tick marks indicating units or sub-units of measurement.

By affixing the end hook 170 to the anchor point, the self-retraction assembly 130 (which may be spring loaded in some cases) may be prevented from retracting the paid out portions of the tape 140 into the housing 110 (via the aperture 150). Similarly, when the locking assembly 160 is in a locked position, a force (e.g., a pinching force) may be placed on the tape 140 to prevent retraction or motion of the reel assembly 120. As such, the locking assembly 160 may prevent the self-retraction assembly 130 from retracting the paid out portions of the tape 140. However, when the end hook 170 is not anchored and the locking assembly 160 is unlocked, the self-retraction assembly 130 may cause the reel assembly 120 to wind the tape 140 back onto the reel assembly 120.

According to some example embodiments, when the tape 140 is paid out through the aperture 150, the tape 140 will extend relatively straight out of the aperture 150 (although some sagging or drooping may be noticed due to the weight of the tape 140). The tape 140 can be extended in a guided fashion toward an intended target anchor point while the tape 140 continues to have sufficient rigidity to standout.

Additionally, the distance measuring apparatus 100 may include an optical measurement assistance assembly 180. According to some example embodiments, the optical measurement assistance assembly 180 may include a camera that is configured to capture an image of the extended tape 140 during a measurement workflow by a user. The captured image may be evaluated and analyzed to determine a measurement based on a measurement position that is included in the image as further described herein. The optical measurement assistance assembly 180 may also include other components as described herein according to some example embodiments.

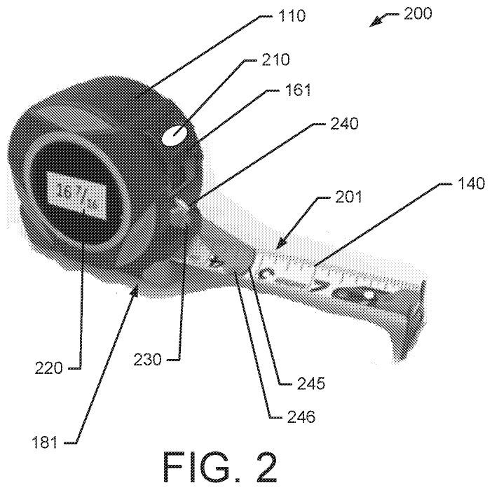

FIG. 2 shows a distance measuring apparatus 200 that has many of the same elements as distance measuring apparatus 100 with the exception of additional detail being provided with respect to the optical measurement assistance assembly 181. Mechanically, the distance measuring apparatus 200 may be embodied and function similar to the distance measuring apparatus 100. The optical measurement assistance assembly for the distance measuring apparatus 200 may include a touch control 210, a display 220, a camera 230, and a light element 240. The distance measuring apparatus 200 may also include a wireless communications interface and an antenna (not shown) configured to support wireless communications with, for example, a mobile terminal (e.g., smart phone) or a wireless network (e.g., WIFI or cellular network). Additionally, the distance measuring apparatus 200 may comprise processing circuitry (not shown, but the same or similar to processing circuitry 1010) configured to control the electronic components of the distance measuring apparatus 200 including the wireless communications interface.

The touch control 210 may be any type of touch control (e.g., push button switch, capacitive touch sensor, etc.). The touch control 210 may permit a user to request that a measurement be taken. As further described below, upon touching or pressing the touch control 210, a request in the form of an image capture signal may be sent to the camera 230 to capture an image of the measuring tape 140. As seen in FIG. 2, the touch control 210 may be placed, for example, on the locking slider 161 of the locking assembly.

The display 220 may be configured to present to a user the measurement that is being taken. In this regard, the display 220 may be a liquid crystal display configured to provide information to the user of the distance measuring apparatus 200.

The camera 230 may be affixed to or disposed within the housing 110. The camera 230 may be a digital camera capable of capturing an image of the measuring tape 140. The camera 230 may be disposed in a fixed position relative to the housing 110 and therefore a field of view of the camera 230 may be static relative to the housing 110, according to some example embodiments. The light element 240, which may be an light emitting diode (LED), may illuminate the tape 140 with an illumination indicator 246 at a predetermined measurement position 245 to indicate the measurement position 245 to the user. The illumination indicator 246 may be, for example, a red line that extends beyond the edges of the measuring tape 140. Further, the illumination indicator 246 may be presented as a moving point that draws a line back and forth at the measurement position 245.

As such, the camera 230 may be pointed at a fixed field of view relative to the housing 110 and the measuring tape 140 may move relative to and through the field of view of the camera 230 as the measuring tape 140 is extended out of the housing 110. Further, the measurement position 245 may be a fixed position within the field of view of the camera 230, and the measurement position 245 may be indicated by an illumination indicator 246 provided by a light element 240.

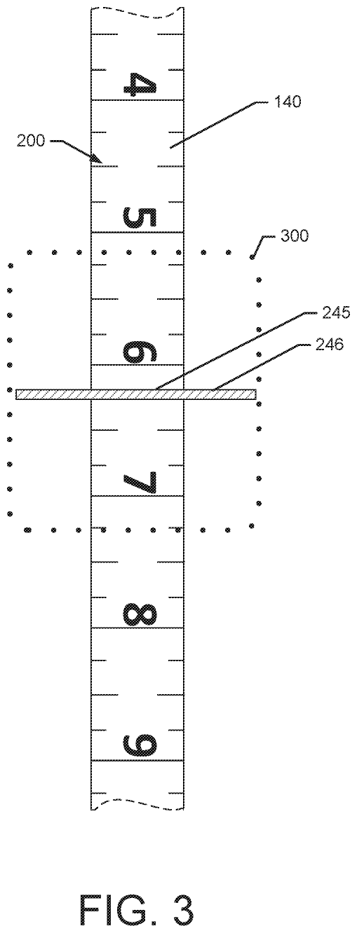

With reference to FIG. 3, an example process for determining a measurement is provided. In this regard, the process may begin by a user extending the measuring tape 140 from the housing 110 to align the tape 140 with an item to be measured. According to some example embodiments, the extension of the measuring tape 140 out of the housing 110 may be detected, for example, via an end hook switch or sensor that detects when the end hook 170 is not in the retracted position. Upon detection of the extension of the measuring tape 140 (e.g, that the end hook 170 is not in the retracted position), the distance measuring apparatus 100 and its processing circuitry may enter a measurement mode. In the measurement mode, the processing circuitry may be configured to activate the light element 240 to provide the illumination indicator 246 to indicate to the user where the measurement position 245 is located. The user may then align the illumination indicator 246 and the measurement position 245 with the item to be measured such that the desired measurement is at the measurement position 245.

Upon aligning the desired measurement with the measurement position 245, the user may depress or touch the touch control 210 thereby sending an image capture signal to the processing circuitry to be received by the processing circuitry. In response, the processing circuitry may be configured to cause the camera 230 to capture an image of the measuring tape 140. In this regard, the camera 230 may capture an image of the camera 230's field of view 300 shown in FIG. 3. The field of view 300 and therefore the captured image includes the distance measurement indicia 200 including the numbering, the tick marks, and the illumination indicator 246.

Having captured the image including the distance measurement indicia 200, including the numbering, the tick marks, and the illumination indicator 246, the processing circuitry may be configured to perform an image analysis to determine a measurement. In this regard, the measurement is a value (e.g., 6 feet 10 inches, 6.5 feet, 3 meters, or the like). Since the illumination indicator 246 indicates the measurement position 245, the processing circuitry may use the distance measurement indicia 200 to determine where the measurement position 245 is on the measuring tape 140. In the example of FIG. 3, processing circuitry may be configured to identify the number “6” on the measuring tape 140 and determine that the illumination indicator 246 is aligned with the ¼ tick mark after the full line across for “6”. As such, the processing circuitry may determine that the measurement position 245 is located at 6 and ¼ inches.

Upon determining the measurement, the processing circuitry may be configured to store the measurement in a memory device. The memory device may be housed within the housing 110 or the memory device may be remote. In this regard, the processing circuitry may leverage the wireless communications interface to communicate the measurement to, for example, a mobile terminal (e.g., via Bluetooth) or a network (e.g., via WIFI). In this regard, the measurement may be stored on the mobile terminal or on a cloud server. Additionally, the processing circuitry may present the measurement on the display 220.

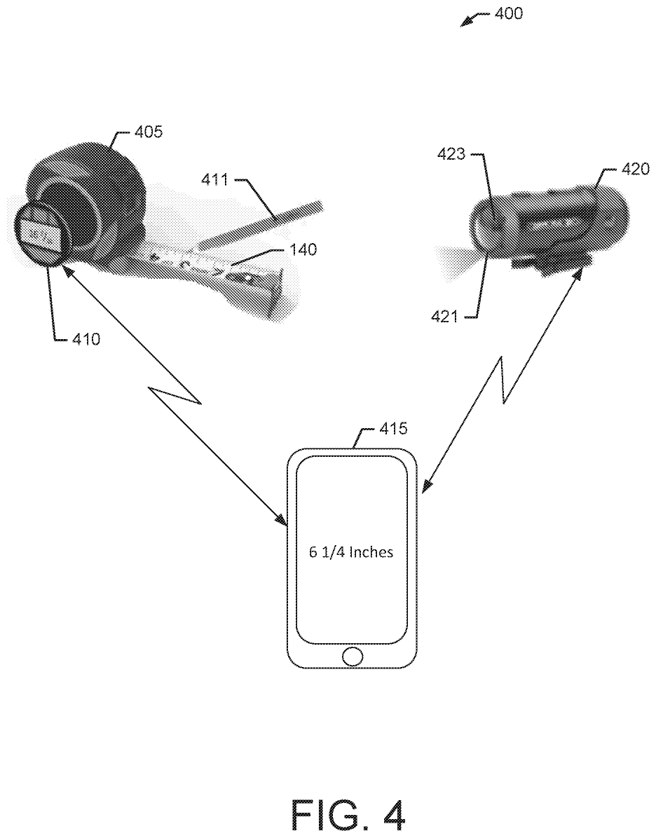

Another example embodiment of a distance measuring apparatus 400 is shown in FIG. 4. In this regard, rather than the components and functionalities being housed in a single device as described with respect to distance measuring apparatuses 100 and 200, the distance measuring apparatus 400 employs a distributed approach to form the optical measurement assistance assembly.

In this regard, the distance measuring apparatus 400 may comprise a tape measure 405 having a tape measure component 410, a mobile terminal 415, and a camera component 420 having a camera 423. These elements may operate together to assist a user with making measurements using captured image analysis. The tape measure 405 may mechanically operate similar to the distance measuring apparatus 100 described above with respect to FIG. 1. The tape measure component 410 may be an electronic device that includes a processor, a display, a touch control, and a wireless communications interface including an antenna. According to some example embodiments, the tape measure component 410 may be an attachable and removable from the tape measure 405. In this regard, the tape measure component 410 may be part of an add-on or upgrade kit to a purely mechanical tape measure 405. According to some example embodiments, the tape measure 405 may be used in conjunction with a pointing member (e.g., a pencil) having a tip that may be used to indicate the measurement position for the distance measuring apparatus 400. According to some example embodiments, the tip of the pointing member 411 may be a certain color that may improve its contrast in a captured image.

The mobile terminal 415 may be any type of smart phone, tablet, or the like that is configured to run, for example, an application (or “app”) that configures the mobile terminal 415 to assist with taking measurements. According to some example embodiments, the mobile terminal 415 may be affixed to or incorporated into another tool, such as a power tool (e.g., saw) that may, for example, be configured to cut materials that have been measured. The mobile terminal 415 may be a core component of the optical measurement assistance assembly for distance measuring apparatus 400 as further described below, with the tape measure 405 (with the tape measure component 410) and the camera component 420 operating as peripheral devices. The mobile terminal 415 may include processing circuitry configured to, for example, receive and analyze a captured image of the measuring tape 140 of tape measure 405. In this regard, the mobile terminal 415 may include a communications interface capable of linking with the tape measure component 410 and the camera component 420 via, for example, Bluetooth.

The camera component 420 may include a camera 423, which may be a digital camera. The camera component 420 may also include a communications interface for linking with the mobile terminal 415. The camera component 420 may include a mounting assembly configured to affix the camera component 420 and the camera 423 to a user-wearable article such as a helmet, hat, glasses, or the like that may permit the field of view of the camera 423 to be pointed in a direction of a field of view of a user. In this regard, the camera component 420 may also include a light element 421 that forms an illumination indicator for the user to assist in aiming the camera's field of view.

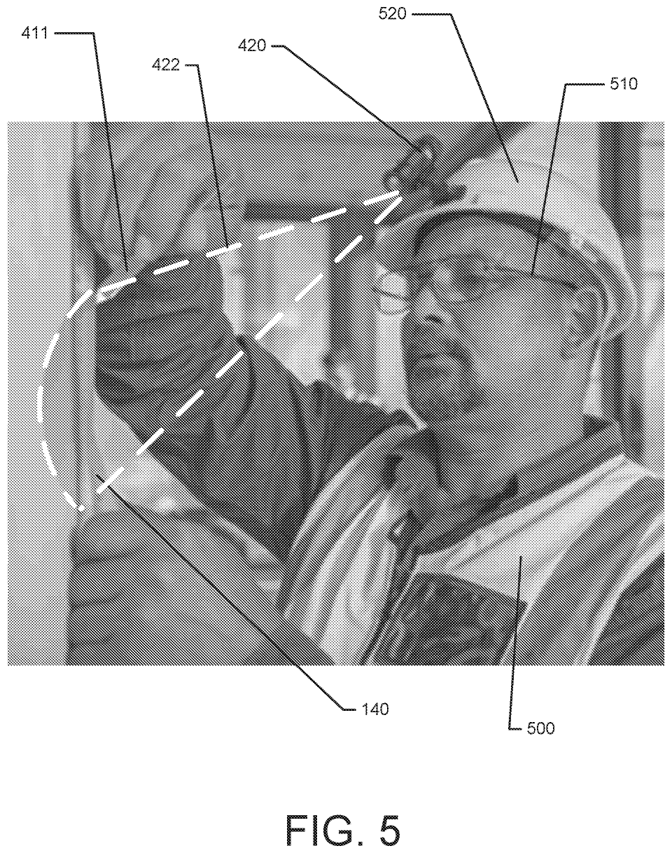

With reference to FIG. 5, a user 500 is shown utilizing the distance measuring apparatus 400. In this regard, it can be seen that camera component 423 is affixed to the user 500's helmet 520. Notably, as mentioned above, the camera component 423 may alternatively be affixed to the user 500's glasses 510, or another wearable article. The light element 421 of the camera component 420 may cast an illumination indicator 422 to assist the user 500 in aiming the camera 420's field of view to facilitate determining a measurement on the measuring tape 140. The user 500 is also shown as using a pointing member 411 to indicate a measurement position that is within the illumination indicator 422 and thus the camera 420's field of view.

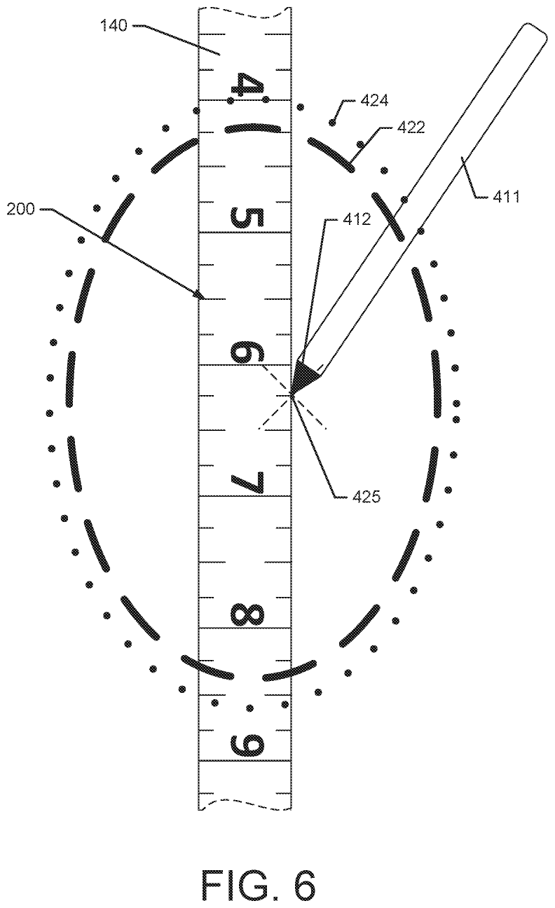

With reference to FIG. 6, an example process for determining a measurement is provided with respect to the distance measuring apparatus 400. In this regard, the process may begin by a user extending the measuring tape 140 from the housing of the tape measure 405 to align the tape 140 with an item to be measured. The user may then use a pointing member 411 to indicate where on the measuring tape 140 the measurement position 425 is to be located. In this regard, unlike the relatively fixed location of the measurement position 245 of distance measuring apparatus 200, the distance measuring apparatus 400 may use a dynamic measurement position 425 that is indicated by a pointing member 411 in the captured image. According to some example embodiments, the extension of the measuring tape 140 out of the housing may be detected as described above, or a touch control may be touched/pressed by the user to enter into the measurement mode. In the measurement mode, the tape measure component 410 may communicate a signal regarding entry into the measurement mode to the mobile terminal 415, which in turn, may communicate to the camera component 420 that the light element 421 may be activated to generate the illumination indicator 422. The user may then align the illumination indicator 422 and the measurement position 425, by indicating with the pointing member 411, with the item to be measured such that the desired measurement is at the measurement position 425.

FIG. 6 illustrates this point in the process. The illumination indicator 422 is shown as having the tip 412 of the pointing member 411 within the illumination indicator 422's area. Accordingly, the tip 412 of the pointing member 411 is also in the field of view 424 of the camera 423 due to the relationship between the illumination indicator 422's area and the field of view 424 of the camera 423. According to some example embodiments, the illumination indicator 422's area may be the same size or smaller than the camera 423's field of view 424, as long as the illumination indicator 422's area is within the camera 423's field of view.

Upon aligning the desired measurement with the tip 412 of the pointing member 411, the user may depress or touch a touch control on the tape measure component 410 thereby sending an image capture signal to the processing circuitry of the mobile terminal 415 to be received by the processing circuitry. In response, the processing circuitry may be configured to transmit a signal to the camera component 420 to cause the camera 423 to capture an image of the field of view 424 of the camera 423, which should include the measuring tape 140 and the tip 412. In this regard, the camera 423 may capture an image of the camera 423's field of view 424 as shown in FIG. 6. The field of view 424, and therefore the captured image, includes the distance measurement indicia 200 including the numbering, the tick marks and the tip 412.

Having captured the image including the distance measurement indicia 200 including the numbering, the tick marks, and the tip 412, the camera component 420 may transmit the captured image to the processing circuitry of the mobile terminal 415 for analysis to determine the measurement. The processing circuitry of the mobile terminal 415 may be configured to perform an image analysis to determine the measurement. The processing circuitry of the mobile terminal 415 may be configured to isolate the tip 412 in the image (possibly based upon the tip 412's color) to determine the measurement position 425 and, based on the measurement position 425, determine the closest tick marks of the distance measurement indicia 200. Accordingly, based on the measurement position 425 and the distance measurement indicia 200, the measurement may be determined. In the example of FIG. 6, processing circuitry may be configured to identify the relationship between the measurement position 425 and the number “6” on the measuring tape 140 and determine that the measurement position 425 is aligned with the ¼ tick mark after the full line across for “6”. As such, the processing circuitry may determine that the measurement position 425 is located at 6 and ¼ inches.

Upon determining the measurement, the processing circuitry may be configured to store the measurement in a memory device of the mobile terminal 415. The processing circuitry may alternatively or additionally leverage the wireless communications interface of the mobile terminal 415 to communicate the measurement to, for example, a network (e.g., via WIFI). In this regard, the measurement may be stored on the mobile terminal 415 or on a cloud server. Additionally, the processing circuitry may transmit the measurement to the tape measure component 410 to present the measurement on the display.

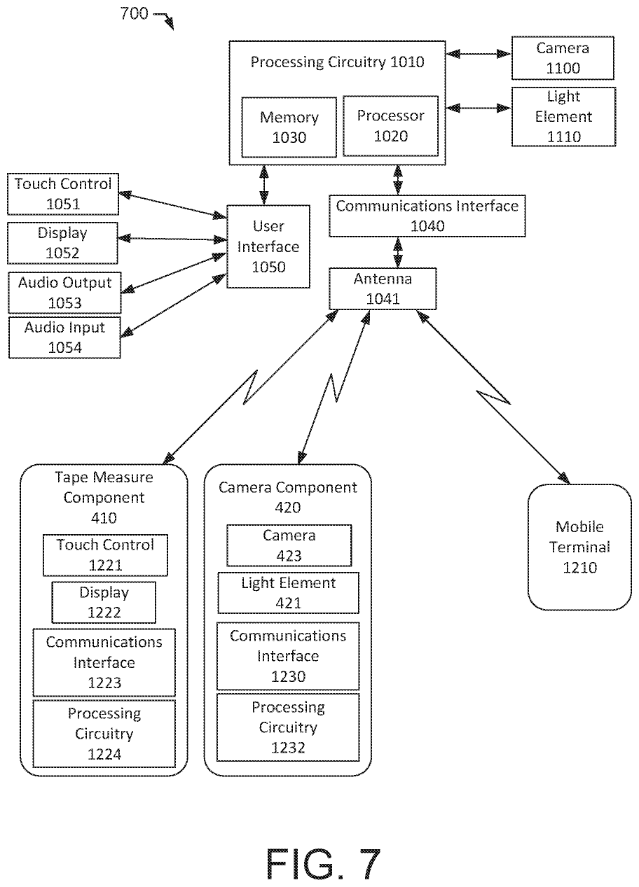

FIG. 7 provides a block diagram of the electrical components of an example distance measuring apparatus 700 according to some example embodiments. Although not shown in FIG. 7, it is contemplated that the apparatus 700 includes the mechanical components of distance measuring apparatus 100, including, the measuring tape 140 with distance measurement indicia 200. As described above, some example embodiments are described as having the components of an optical measurement assistance assembly located on a single tape measure device or distributed across a number of devices with wireless communication links. The distance measuring apparatus 700 of FIG. 7 is described as supporting both of these types of embodiments.

Accordingly, FIG. 7 shows a block diagram of some components of a distance measuring apparatus 700 that comprises processing circuitry 1010 that may be in operative communication with or embody, a communications interface 1040 and a user interface 1050. The processing circuitry 1010 may interact with or embody a memory 1030 and a processor 1020. The processing circuitry 1010 is configurable to perform operations described herein. In this regard, the processing circuitry 1010 may be configured to perform computational processing and memory management according to an example embodiment. In some embodiments, the processing circuitry 1010 may be embodied as a chip or chip set. In other words, the processing circuitry 1010 may comprise one or more physical packages (e.g., chips) including materials, components or wires on a structural assembly (e.g., a baseboard). The processing circuitry 1010 may be configured to receive inputs (e.g., via peripheral components including the memory 1030), perform actions based on the inputs, and generate outputs (e.g., for provision to peripheral components). In an example embodiment, the processing circuitry 1010 may include one or more instances of a processor 1020, associated circuitry, and memory 1030. As such, the processing circuitry 1010 may be embodied as a circuit chip (e.g., an integrated circuit chip, such as a field programmable gate array (FPGA)) configured (e.g., with hardware, software or a combination of hardware and software) to perform operations described herein.

In an example embodiment, the memory 1030 may include one or more non-transitory memory devices such as, for example, volatile or non-volatile memory that may be either fixed or removable. The memory 1030 may be configured to store information, data, applications, instructions or the like for enabling, for example, image recognition and presentation and to carry out various functions in accordance with exemplary embodiments. For example, the memory 1030 could be configured to buffer input data for processing by the processing circuitry 1010. Additionally or alternatively, the memory 1030 could be configured to store instructions for execution by the processing circuitry 1010. Among the contents of the memory 1030, applications may be stored for execution by the processing circuitry 1010 in order to carry out the functionality associated with each respective application.

As mentioned above, the processing circuitry 1010 may be embodied in a number of different ways. For example, the processing circuitry 1010 may be embodied as various processing means such as one or more processors 1020 that may be in the form of a microprocessor or other processing element, a coprocessor, a controller or various other computing or processing devices including integrated circuits such as, for example, an ASIC (application specific integrated circuit), an FPGA, or the like. In an example embodiment, the processing circuitry 1010 may be configured to execute instructions stored in the memory 1030 or otherwise accessible to the processing circuitry 1010. As such, whether configured by hardware or by a combination of hardware and software, the processing circuitry 1010 may represent an entity (e.g., physically embodied in circuitry—in the form of processing circuitry 1010) capable of performing operations according to example embodiments while configured accordingly. Thus, for example, when the processing circuitry 1010 is embodied as an ASIC, FPGA, or the like, the processing circuitry 1010 may be specifically configured hardware for conducting the operations described herein. Alternatively, as another example, when the processing circuitry 1010 is embodied as an executor of software instructions, the instructions may specifically configure the processing circuitry 1010 to perform the operations described herein.

The communication interface 1040 may include one or more interface mechanisms for enabling communication with other devices external to apparatus 700, via, for example, a network, such as a local area network. In some cases, the communication interface 1040 may be any means such as a device or circuitry embodied in either hardware, or a combination of hardware and software that is configured to receive or transmit data from/to devices in communication with the processing circuitry 1010. The communications interface 1040 may be a wired or wireless interface and may support various communications protocols. Communications interface 1040 may be operably coupled to an antenna 1041 to support wireless communications to other components. In this regard, the communications interface 1040 and the antenna 1041 may support communications via, for example, Bluetooth or WIFI connections.

In an example embodiment similar to distance measuring apparatus 100 or 200, that is where the optical measurement assistance assembly located on a single tape measure device, the communications interface may wirelessly link to the mobile terminal 1210 to, for example, transmit measurement information. Alternatively, in an example embodiment where the optical measurement assistance assembly is distributed across a number of devices, the processing circuitry 1010 may be housed in a mobile terminal and the communications interface 1040 may wirelessly link to the tape measure component 410 and the camera component 420, as shown here in FIG. 7 as well as FIG. 4.

As described above, the tape measure component 410 may include a touch control 1221, a display 1222, a communications interface 1223, and processing circuitry 1224. The tape measure component 410 may be affixed to or disposed within a housing that is shared with the measuring tape 140. The tape measure component 410 may be removable from this shared housing. The processing circuitry 1224 may be physically similar to the processing circuitry 1010, although configured differently to support the operations of the distance measuring apparatus 700. The processing circuitry 1224 may be configured to control and monitor the operations of the tape measure component 410 generally and the touch control 1221, the display 1222, and the communications interface 1223. The communications interface 1223 may operate similar to the communications interface 1040 and may include an antenna. The touch control 1221 may be configure to initiate the sending of an image capture signal to the processing circuitry 1010.

As described above, the camera component 420 may include a camera 423, a light element 421, a communications interface 1230, and processing circuitry 1232. According to some example embodiments, the camera component 420 may be affixed or affixable to a user-wearable article. The processing circuitry 1232 may be physically similar to the processing circuitry 1010, although configured differently to support the operations of the distance measuring apparatus 700. The processing circuitry 1232 may be configured to control and monitor the operations of the camera component 420 generally and the camera 423, the light element 421, and the communications interface 1230. The communications interface 1230 may operate similar to the communications interface 1040 and may include an antenna. The light element 421 may be configured to illuminate an area indicating a field of view of the camera 423.

The user interface 1050, associated with the processing circuitry 1010, may be controlled by the processing circuitry 1010 to interact with a user. In this regard, via the user interface 1050, the processing circuitry 1010 may be configured to receive inputs from a user via the touch control 1051, which may be the same or similar to the touch control 210 described earlier, or an audio input 1054 (e.g., a microphone). The touch control 1051 may be configured to send an image capture signal to the processing circuitry 1010 upon user interaction with the touch control 1051. The user interface 1050 may also output information to a user by, for example, driving a display 1052 (which may be the same or similar to the display 220) and outputting audio via audio output 1053, which may be for example, a speaker. According to some example embodiments, the user interface may also operably couple to other user input devices such as, for example, a keyboard, mouse, touch screen, or the like. Further, the user interface may also operably couple with the communications interface 1040 to receive inputs and provide outputs to remote devices that are connected via, for example, a wireless connection.

The distance measuring apparatus 700 may also include a camera 1100 and a light element 1110 that are operably coupled to and controlled by the processing circuitry 1010. The camera 1100 may be the same or similar to the camera 230 described above and the light element 1110 may be the same or similar to the light element 240. In this regard, the camera 1100 may be affixed to or disposed within a housing that also houses the measuring tape 140. The camera 1100 may be pointed at a fixed field of view relative to the housing for the measuring tape 140 and the measuring tape 140 may move relative to and through the field of view of the camera 1100 as the measuring tape is extended out of the housing. According to some example embodiments, the measurement position may be a fixed position within the field of view of the camera 1100. The light element 1110 may be configured to illuminate the measurement position.

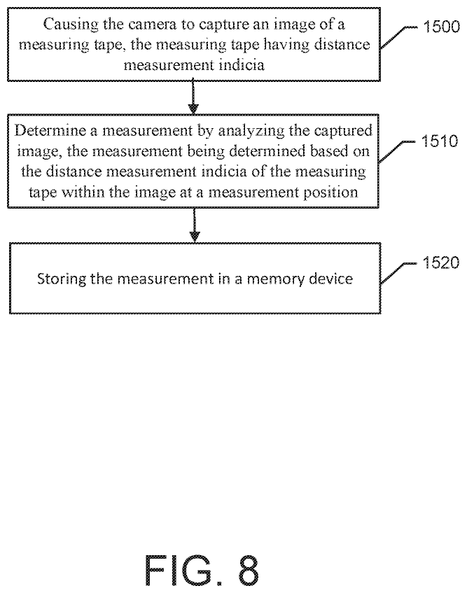

In an example embodiment, the processing circuitry 1010 may be embodied as, include or otherwise control, the apparatus 700 to perform object recognition and presentation as described herein. As such, in some embodiments, the processing circuitry 1010 may be said to cause each of the operations described in connection with, for example, the distance measuring apparatus 100, 200, and 400, and the method of FIG. 8, and the functionalities otherwise described herein. The processing circuitry 1010 may therefore undertake the corresponding functionalities responsive to execution of instructions or algorithms configuring the processing circuitry 1010 accordingly. The processing circuitry 1010 may provide programmable control signals, selections, and the like to control the operation of the apparatus 700 responsive to execution of instructions stored in the memory 1030.

According to some example embodiments, the processing circuitry 1010 may be configured to cause the camera 1100 to capture an image of the measuring tape 140, and determine a measurement by analyzing the captured image. In this regard, the measurement may be determined based on the distance measurement indicia 200 of the measuring tape 140 within the image at a measurement position (e.g., measurement position 245 or 425). The processing circuitry 1010 may also be configured to store the measurement in a memory device, such as memory device 1030.

According to some example embodiments, the processing circuitry 1010 may be configured to cause the camera 1100 to capture the image in response to receiving the image capture signal from the touch control 1051. Further, according to some example embodiments, the processing circuitry 1010 may be further configured to present, via the display 1052, the measurement. According to some example embodiments, the processing circuitry 1010 may be configured to transmit, via the wireless communications interface, the measurement to a mobile terminal 1210 or a network.

As mentioned above, according to some example embodiments, the processing circuitry 1010 may be housed in a mobile terminal (e.g., mobile terminal 415). According to some example embodiments, the processing circuitry 1010 may be configured to determine the measurement position based a tip of a pointing element in the image.

FIG. 8 shows an example method according to various example embodiments. In this regard, the method of FIG. 8 may be performed by the apparatus 700 described above. The example method may comprise, at 1500, causing the camera to capture an image of a measuring tape. The measuring tape may have distance measurement indicia. The example method may further comprise determining a measurement by analyzing the captured image. In this regard, the measurement may be determined based on the distance measurement indicia of the measuring tape within the image at a measurement position. Additionally, the example method may include, at 1520, storing the measurement in a memory device.

According to some example embodiments, the example method may further comprise illuminating the measurement position with a light element. The example method may further comprise determining the measurement position based on a tip of a pointing element included in the image.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A distance measuring apparatus comprising:
a measuring tape with distance measurement indicia;
a camera; and
processing circuitry configured to:
cause the camera to capture an image of the measuring tape;
determine a measurement by analyzing the captured image, the measurement being determined based on the distance measurement indicia of the measuring tape within the image at a measurement position; and
store the measurement in a memory device.

2. The distance measuring apparatus of claim 1, wherein the measuring tape is configured to be rolled into a housing and wherein the camera is affixed to or disposed within the housing.

3. The distance measuring apparatus of claim 1, wherein the measuring tape extends out of a housing as the measuring tape is unrolled, wherein the camera is pointed at a fixed field of view relative to the housing and the measuring tape moves relative to and through the field of view of the camera as the measuring tape is extended out of the housing; and wherein the measurement position is a fixed position within the field of view of the camera.

4. The distance measuring apparatus of claim 1 further comprising a light element, the light element configured to illuminate the measurement position.

5. The distance measuring apparatus of claim 1, further comprising a touch control, the touch control being configured to send an image capture signal to the processing circuitry; and
wherein the processing circuitry is configured to cause the camera to capture the image in response to receiving the image capture signal.

6. The distance measuring apparatus of claim 1, further comprising a display; and wherein the processing circuitry is further configured to present, via the display, the measurement.

7. The distance measuring apparatus of claim 1, further comprising a wireless communications interface; and wherein the processing circuitry is configured to transmit, via the wireless communications interface, the measurement to a mobile terminal or a network.

8. The distance measuring apparatus of claim 1, wherein the camera is affixed to a user-wearable article and the processing circuitry is housed in a mobile terminal.

9. The distance measuring apparatus of claim 1, wherein the apparatus further comprises a tape measure component comprising:
a touch control, the touch control being configured send an image capture signal to the processing circuitry; and
a display configured to display the measurement;
wherein the measuring tape is disposed within a housing; and
wherein the tape measure component is affixed to or disposed within the housing.

10. The distance measuring apparatus of claim 9, wherein the tape measure component is removable from the housing.

11. The distance measuring apparatus of claim 1, wherein the processing circuitry configured to determine the measurement includes being configured to determine the measurement position based a tip of a pointing element in the image.

12. The distance measuring apparatus of claim 1, further comprising a light element, the light element configured to illuminate an area indicating a field of view of the camera.

13. A distance measuring apparatus comprising:
a housing having an aperture;
a reel assembly;
a measuring tape having a first end configured to extend from the housing through the aperture and a second end configured to be wound on the reel assembly, the measuring tape having distance measurement indicia; and
a touch control, the touch control being configured send a signal to have a camera capture an image of the distance measurement indicia at a measurement position.

14. The distance measuring apparatus of claim 13, further comprising a display configured to display the measurement.

15. The distance measuring apparatus of claim 13, further comprising an antenna configured to support a wireless communications connection to a mobile terminal.

16. The distance measuring apparatus of claim 13, further comprising processing circuitry configured to:
cause the camera to, in response to the signal from the touch control capture the image of the measuring tape;
determine a measurement by analyzing the captured image, the measurement being determined based on the distance measurement indicia of the measuring tape within the image at the measurement position; and
store the measurement in a memory device.

17. The distance measuring apparatus of claim 13, further comprising the camera, wherein the camera is pointed at a fixed field of view relative to the housing and the measuring tape moves relative to and through the field of view of the camera as the measuring tape is extended out of the housing; and wherein the measurement position is a fixed position within the field of view of the camera.

18. A method comprising:
causing the camera to capture an image of a measuring tape, the measuring tape having distance measurement indicia;
determining a measurement by analyzing the captured image, the measurement being determined based on the distance measurement indicia of the measuring tape within the image at a measurement position; and
storing the measurement in a memory device.

19. The method of claim 18 further comprising illuminating the measurement position with a light element.

20. The method of claim 18 further comprising determining the measurement position based on a tip of a pointing element included in the image.
